(19) United States
(12) Patent Application Publication
(10) Pub. No.: US 2014/0232617 A1
(43) Pub. Date: Aug. 21, 2014

(54) COMPUTERIZED DEVICE WITH A PLURALITY OF VARIABLY CONFIGURED DISPLAY SCREENS

(71) Applicant: Doris Nkiruka Anite, Victoria Island (NG)

(72) Inventor: Doris Nkiruka Anite, Victoria Island (NG)

(21) Appl. No.: 13/772,308

(22) Filed: Feb. 20, 2013

(51) Int. Cl. G06F 3/14

(52) U.S. Cl. CPC G06F 3/1446
USPC 345/1.3

(57) ABSTRACT

A method for providing multiple display screens for a computerized device. Here a plurality of display screens, often four are more, created, each with edges that contain mechanical or magnetic clasps, as well as electrical connectors for communicating display information and optionally power. These screens are stacked in a receptacle in the device's body, usually with at least one screen capable of facing the user and displaying information in the stacked configuration. Upon removal from the stack, the various displays may be snapped together to form a larger planar multiple-display surface, which often may be disposed in various configurations depending upon user preference. Each display may optionally have its own battery, orientation sensor, or camera, and can receive and show display information from the devices' processor, as well as optionally transmit display orientation or camera information back to the processor, which in turn may adjust the display accordingly.

### BACKGROUND OF THE INVENTION

1. Field of the Invention

This invention is in the field of display screen hardware for computerized devices such as desk or laptop computers, smartphones, and tablet computers.

2. Description of the Related Art

As computers and computerized devices, and in particular as smaller handheld computerized devices with limited size and corresponding limited video screen viewing have proliferated, the problem of how to adequately utilize such limited size display screens has grown. This problem has become particularly intense as high speed internet technology and memory storage technology now makes it feasible to provide such devices with an increasingly large amount of graphics, text, and video information.

Various companies have elected to deal with problem of the limited display screen sizes in various ways. Apple computer corporation, Cupertino California, has generally elected to address the problem by attempting to pack an ever larger number of pixels into the limited video screen surface area. This solution may work adequately for younger users, but is more problematic for older users who often have difficulty focusing their eyes on small screens at close range.

Other approaches include the art of Karayanaswamy et. al., U.S. Pat. No. 6,144,358. Karayanaswamy teaches electronic devices with clamshell type open and closed configurations. Each clamshell contains a display screen. Various organizations have adopted this approach including Kyocera Corporation, with global headquarters in Kyoto Japan. Kyocerta produces the Kyocera Echo™ smartphone. This smartphone has two display screens arranged in a clamshell type device so that when the clamshell is opened, both display screens can be seen on either side of the clamshell hinge. This dual screen approach is also used with popular electronic video gaming devices such as the Nintendo Gameboy DS.

In spite of these advances, many computerized devices still have video display screens with insufficient display screen surface area. Thus further advances in the field would be desirable.

### BRIEF SUMMARY OF THE INVENTION

The invention is based, in part, on the insight that although it is occasionally desirable to increase the effective display surface viewing area of a computerized device when needed (for example to view web pages, look at complex images, and the like), for many applications, such as when the device is a portable smartphone, larger displays can also make the device very cumbersome. Thus methods that can temporarily increase the effective display area of a computerized device when needed, and then decrease the effective display area when not needed, are useful.

The invention is also based, in part, on the insight that prior art clamshell type configurations, such as exemplified by U.S. Pat. No. 6,144,358 can at best provide only a limited increase in display area.

The invention is also based, in part, on the insight that as display screen technology has advanced, the actual display screen panels have generally become thinner over time. Extrapolating on these trends suggest that it will become increasingly feasible to stack a plurality of such display screens on top of each other, while still limiting the depth of the stack. That is the depth of the stack will remain small enough that it becomes feasible to add a display panel stack receptacle to a computerized device without making the depth of the computerized device itself objectionably large.

The invention is also based, in part, on the insight that depending upon the situation, different sized displays are optimum. When reading columns of text, display screens that are tall and thin (relative to the device's major axis orientation) might be more desirable. When reading spreadsheets composed of many columns, display screens that are shorter, wider, and perpendicular to the device's major axis might be more desirable. When showing a presentation to another individual, perhaps in a café like environment, a hinged display with two sides at an acute angle (i.e. angled in an upside down “V” like configuration) that would allow both the device user and other individuals to each have their own display screen might be preferable.

To do this, ideally such a plurality of displays might be designed to allow the different displays to be arranged in different configurations, depending upon the user's needs. Additionally, some or all of the plurality of displays should preferably also contain orientation sensors, and communicate the display's relative position back to the computerized device's processor. This way the computerized device processor can be aware of the orientation of each individual display, and adjust the information that is being sent to that display (i.e. change orientation, angle, screen size in pixels) accordingly.

Thus in one embodiment, the invention may be a method for providing multiple display screens for a computerized device, which will often be a small handheld computerized device. Here a plurality of display screens, often four are more, may be obtained or created. These display screens will generally be thin rectangular screens, with a major width and length axis, and a smaller height axis. Each display screen will generally have six sides. Two of the sides (i.e. the front and back of the display screen) will be major sides along the major width and length axis, and four of the sides (i.e. the edges of the display screen) formed by the height and width axis, or the height and length axis, will be edge sides. At least one major side, here termed the “top” side, will have the majority of its surface area occupied by a display screen panel or other display device (e.g. an LCD, electronic paper, or other type display screen panel). The opposite side, here termed the “bottom side” may or may not have its own display panel.

In some embodiments, each of the multiple display screens may have at least one edge, and often two or more edges that contain mechanical or magnetic clasps, as well as electrical connectors for communicating display information and optionally power.

The multiple display screens may designed to exist in two configurations. In one configuration, the multiple display screens may be stacked in a receptacle in the computerized device's body. Often it will be desirable to configure this receptacle, display stack, and clasp and connector configuration so that at least one display screen at the top of the stack remains functional. That is, capable of facing the user and displaying information while the plurality of displays remain in the stacked configuration.

In the second configuration, upon removal from the display stack, the various displays may be arranged (often by snapping together using their clasps, or unfolding the displays) to form a larger planar multiple-display surface. In a preferred embodiment, the display screens may be configured in a manner that allows them be disposed in various configurations depending upon user preference. In some embodiments, each display screen may optionally have some combination of either its own battery, orientation sensor, or camera. These display screens may be configured so that they are capable of receiving and showing display information from the electronic device's processor. The display screens may also be configured to transmit display orientation or camera information back to the electronic device's processor, which in turn may adjust the display accordingly.

### BRIEF DESCRIPTION OF THE DRAWINGS

FIG. 1 shows how a plurality of display screens may be stored in a computerized device receptacle in first configuration, thus exposing only one display for view. The display screens may then be reconfigured into a second configuration, where all screens are may be disposed in a flat, planar array, thus creating a composite display with much larger surface area.

FIG. 2 shows how “n” displays may be arranged in a linear “1×n” array, for example along the main axis of the computerized device.

FIG. 3 shows how “n” displays may be arranged in an alternative “n×1” array, for example perpendicular to the main axis of the computerized device.

FIG. 4 shows more detail on one type of mechanical or magnetic clasps that may be disposed along one or more edges (often two or more) of the display screens, along with electrical connections that can communicate electrical signals (and optionally power) from the computerized device to the display screens. The display screens may optionally use these electrical connectors to also transfer electrical signals and power from one display to another display. This later option would allow even the furthest display to receive display screen electrical signals, which carry the display screen information, from the device's processor.

FIG. 5 shows a closer detail showing a single display screen showing the device's display panel, the display screen's main chassis, an optional battery, and other components. The display screen's optional clasps and optional electrical connections are also shown. In alternative embodiments, the display screen may alternatively receive display information from the device processor using wireless methods, such as Bluetooth™, or other short range wireless protocol.

### DETAILED DESCRIPTION OF THE INVENTION

The inventions, devices, and methods described herein are intended to provide a reconfigurable display for a computerized device. These computerized devices will typically consist of at least one processor (often a microprocessor such as an x86 processor, some variant of the popular ARM series of processors, and the like). The computerized device will additionally consist of computer memory, and usually various types of software such as operating system software, display drivers, GUI system software, and the like. Often the computerized device will also have a network connection, such as a wireless network connection to the internet via WiFi networks, cellular telephone networks, and the like.

Although the invention is particularly useful for providing additional display area to small handheld computerized devices, such as small tablet computers, smartphones, and the like, this is use is not intended to be limiting. In alternate configurations, the methods described herein can also be used to provide additional display area to desktop computers, laptop computers, and the like.

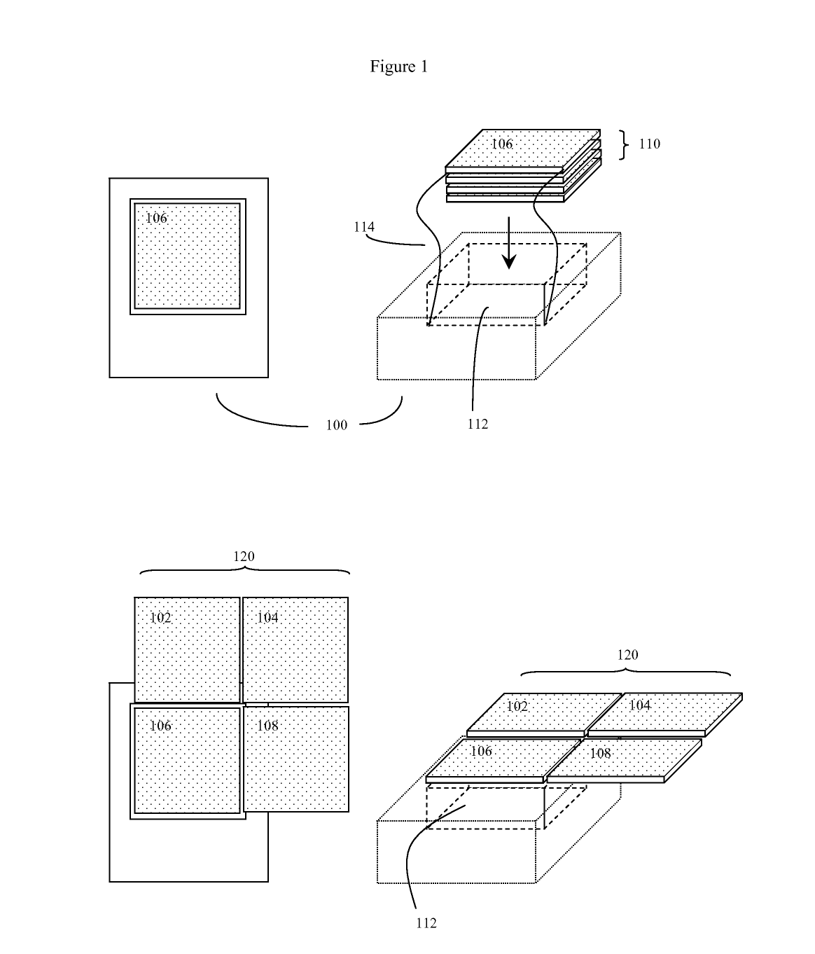

FIG. 1 shows how a plurality of display screens may be stored in a computerized device receptacle in first configuration, thus exposing only one display for view. These display screens may be then removed from the receptacle and reconfigured into a second configuration. In this second configuration, often some or all of the display screens are disposed in a flat, planar array of display screens, thus creating a composite display with much larger surface area.

In some embodiments, the invention may be a method of providing multiple display screens to a computerized device (100), such as the above devices. Note however that in other embodiments, the invention may also comprise a computerized device itself, configured according to the teachings described herein.

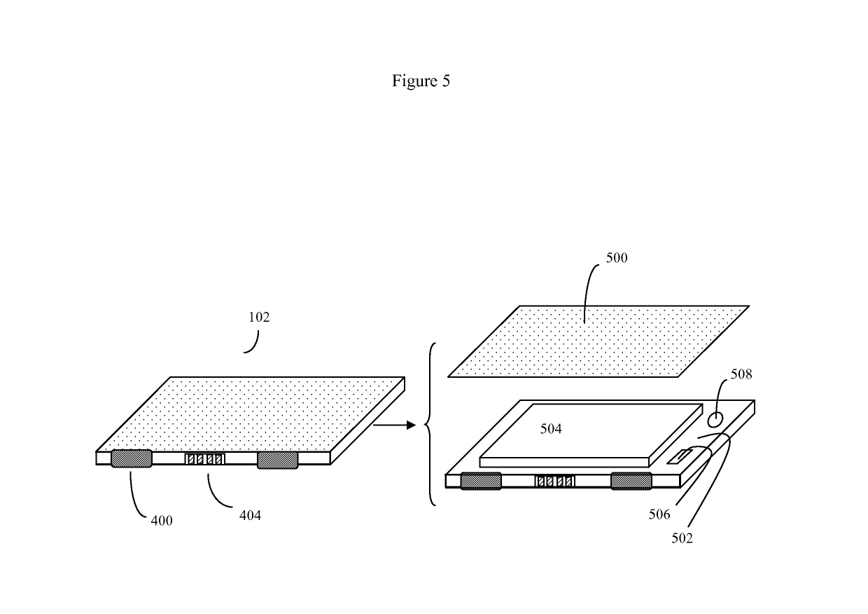

Returning to the methods language, the invention's methods may comprise obtaining or providing a plurality of display screens (e.g. 102, 104, 106, 108) (generally more than two display screens, and often four or more display screens). As previously discussed, the majority of these plurality of display screens may comprise a thin rectangular shape with a display screen on one side (here the “top” side as previously discussed), and often a non-display surface (here the “bottom side as previously discussed) on the other side. The multiple display screens will additionally be configured snap, as a stack of display screens, into a receptacle on a computerized device. Details of one embodiment of such a display screen are shown in more detail in FIG. 5.

The majority, and often all, of this plurality of display screens, at least when configured for non- wireless operation, will often comprise at least one thin edge side comprising electrical connections disposed to communicate display screen electrical signals either to that particular display screen, or from that particular display screen to a neighboring display screen. To facilitate linking the display screens together to form different sized arrays of display screens, often two or more display screen edges will be so configured. In some configurations, all edges may be so configured. If wireless operation is contemplated, the electrical connections need not pass display screen information, but may optionally pass electrical power to facilitate charging display screen batteries if present.

As previously discussed, the majority, and often all of this plurality of display screens will be further configured to transition between at least a first configuration where all screens are snapped or folded together in a stacked configuration (110), with optionally one top screen (e.g. 106) exposed for viewing, and at least one bottom screen (e.g. the rest of the stack) disposed to snap into a receptacle (112) in the body of the computerized device (100). Here, to optionally allow at least one display screen to be operative in this configuration, in some embodiments a cable, such as a cable or ribbon cable (114), or other data and power transfer device may be used to place the display in electrical communication with computerized device (100) and computerized device 100′s at least one processor (not shown). The use of a cable is optional, and in other configurations, electrical contacts and clasps in the computerized device receptacle, or elsewhere on the computerized device, may transmit display information or power.

This receptacle (112) will often be configured to receive this plurality of stacked display screens (110) by either mechanical or magnetic clasps positioned by or in the receptacle (not shown). These mechanical or magnetic clasps may or may not operate with the display screen mechanical or magnetic clasps.

As previously discussed, the display screens will also be configured to allow them to be reconfigured by the user into at least a second configuration where all screens will often be disposed in a flat planar configuration (120). Often each screen will be connected to different screen by the screen edges, so as to provide a continuous display surface. In this second extended configuration, few if any of the screens must be snapped into the body of the computerized device (100). In a preferred embodiment, at least some, and often all of the plurality of display screens will be touch sensitive display screens, capable of transmitting touch data back to the computerized device's processor or processors.

As previously discussed, in some embodiments, it may be useful to equip the computerized device receptacle (112) with electrical contacts configured to transmit display screen electrical signals from the device's processor to at least one of the plurality of display screens. Often these electrical signals will be transmitted to least one edge side of at least display screen, however other configurations are possible. As previously discussed, in some configurations, a cable or ribbon cable (114) may be used to transmit display signals and optionally power to the display screen.

Thus in the first configuration, exemplified by the stacked configuration (110), the computerized device (100) transmits display screen display information to at least one display screen (e.g. screen 106) of the plurality of display screens in the stacked configuration (110). Further, in at least one second configuration, the computerized device (100) will transmit display screen display information to at least a first display screen (e.g. 106) of the plurality of display screens in a flat planar configuration (e.g. 120), and at least a first display screen (e.g. 106) in turn may relay this display screen display information to at least a second display screen (e.g. 102 and/or 104), so that either directly or by relay through other display screens (e.g. screen 104 via screen 102 or 108), all display screens in the flat planar configuration (120) receive display information from the computerized device (100). Alternatively some or all display screens may be configured for wireless operation, and receive display screen information by a wireless connection.

The computerized device processor(s) can thus be configured to transmit a full page of display information to the various display screens when the screens are in the second flat planar configuration (e.g. 120, 200, 300 and the like). By contrast, the processor(s) may automatically only transmit only a fraction of a page of display information to the top screen (e.g. 106) when the various display screens are in their first stacked configuration. Alternatively the processor(s) can rescale the size and resolution of the full page of display information so as to display a scaled-down version of the full page of display information to the top screen (106) when this is required.

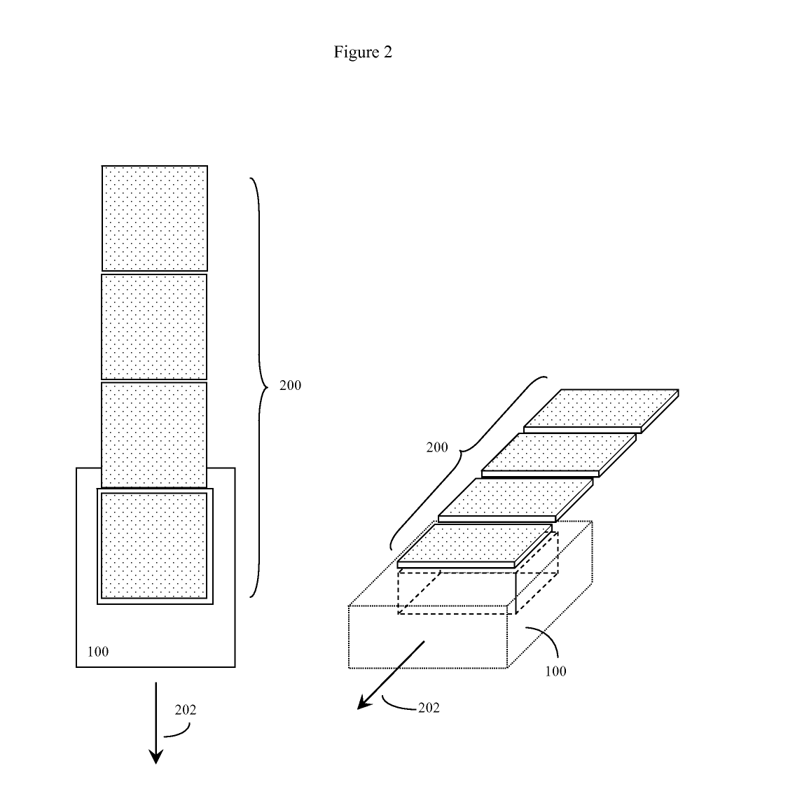

Although FIG. 1 shows the various display screens oriented in a roughly square 2×2 array (or n×n array), many other configurations are possible. One such alternative is shown in FIG. 2, which shows how n displays may be arranged in a linear “1×n” array (200), for example along the main axis (202) of the computerized device (100).

In some configurations, the plurality of display screens (i.e. “n” display screens) may comprises at least four display screens. Here these at least four display screens in turn can snap together to either form a 1×4 (or 1×n) rectangular configuration of display screens.

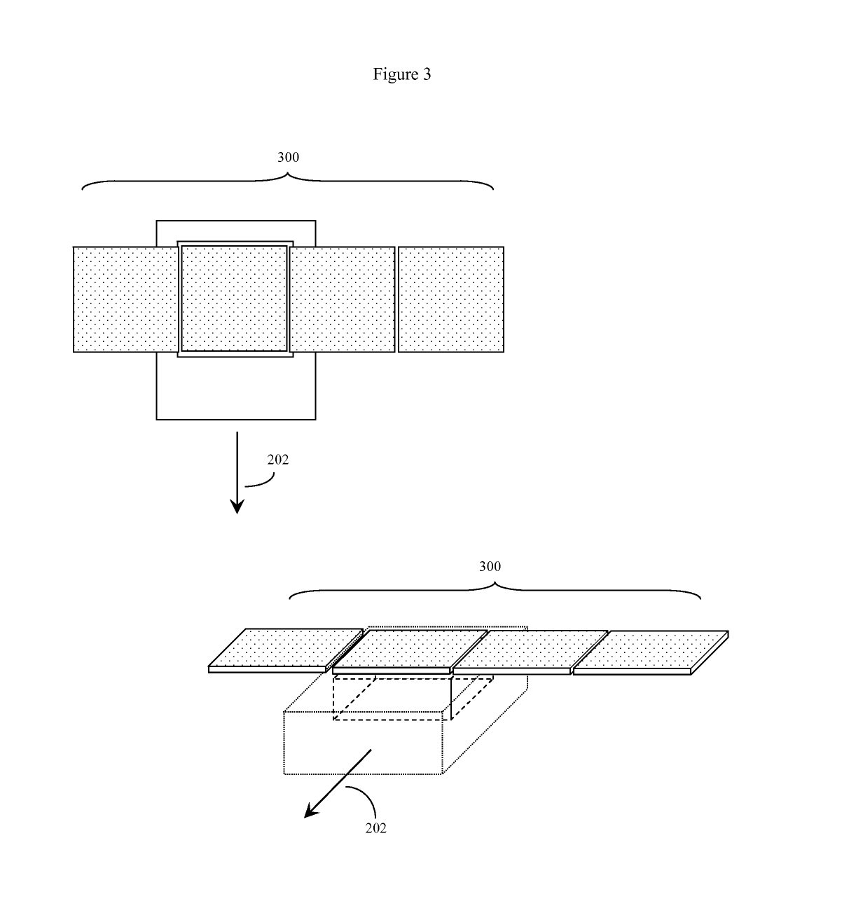

In other configurations, however, the orientation of the “n” array of screens may be perpendicular or some other angle to the main axis (202) of the computerized device (100), as is shown in FIG. 3.

FIG. 3 shows how n displays (300) may be arranged in an alternative “n×1” array, for example perpendicular to the main axis (202) of the computerized device (100).

With some exceptions, generally when in the second flat planar configuration, the plurality of display screens will usually function as one larger display screen. However in a few configurations, such as when the user wishes to share display of a presentation with another individual, the display that might be configured as two separate display screen arrays. where the same basic display information may, for example, be repeated (possibly one set right side up, and the other upside down) between the two displays.

For example, consider a smartphone being used to share information with another individual. Here it might be convenient to arrange the multiple displays to form a “tent” or upside down “V” like configuration. The computerized device user can view one set of display panels, while the other party could view the other set of display panels. The computerized device can transmit a right side up image to the first array of panels being viewed by the computerized device user, and an upside down image to the second array of panels being viewed by the other party (which because the second display array may itself be upside down then will look proper to the other party.

Thus to summarize, in some configurations, the plurality of display screens can comprise four display screens. These four display screens may in turn snap together to form, for example a 2×(1×2) configuration where two screens may be configured to face opposite sides, and each set of two screens displays the same image.

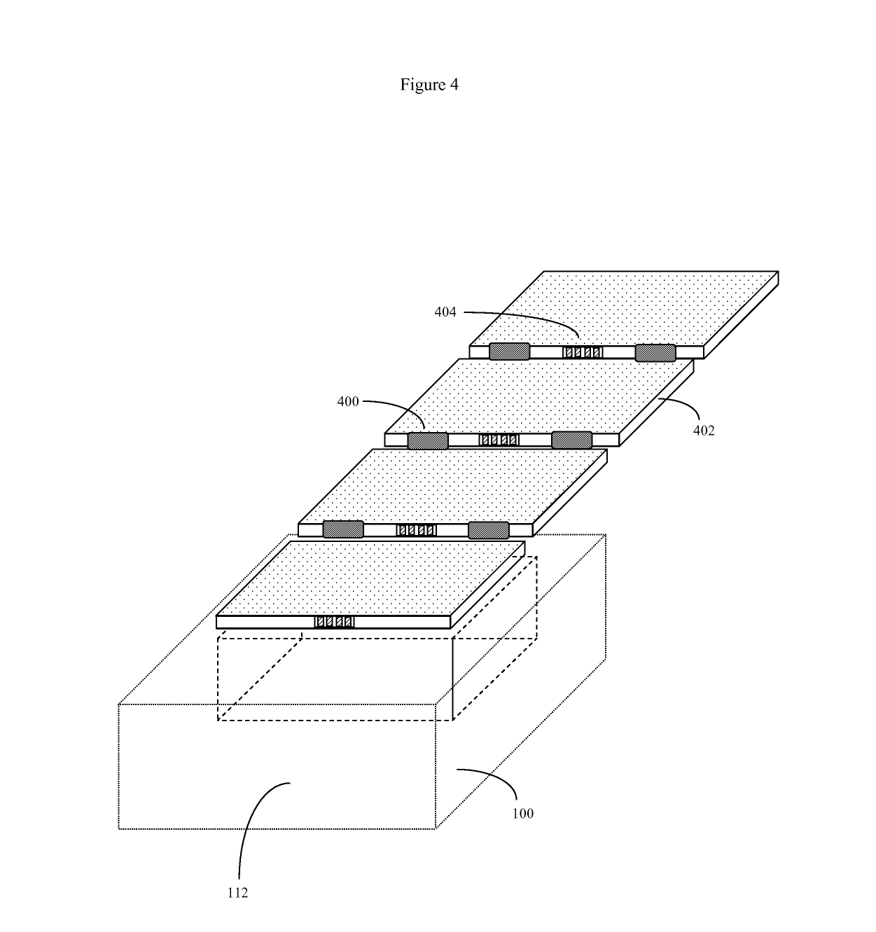

FIG. 4 shows more detail pertaining to the mechanical or magnetic clasps (400) that may be disposed along one or more edges (402) of the display screens, along with optional electrical connections (404) that can communicate display screen electrical signals (and optionally power) from the computerized device (100) to a first display, and then from the first display to another second display, and so on thus allowing even the furthest display to receive display screen electrical signals from the device's processor. In some configurations, all four sides (402) of the display screen may be configured with clasps (404) and electrical connections (404) thus allowing the displays to be flexibly reconfigured into any array pattern that the user desires. To do this, as previously described, the display screens may optionally be configured with sensors to detect their neighboring displays and orientation, and this information will be communicated back to the device's processor, either by way of the edge electrical connections (404) or by wireless communication (e.g. Bluetooth™) as desired.

Some or all of the display screens may additionally have a stand or support for a stand, usually disposed along the back of the display screen (not shown). This can help support the display screens while the screens are operating in their second extended position(s).

Although in many embodiments, electrical connections (404) will also serve to transmit power from device (100) to the various display panels, in other embodiments, electrical connections (404) need not be used to communicate either power or for that matter display information as well. Instead each display screen may have its own electrical power storage device (e.g. battery), and may optionally also communicate with the computerized device (100) via short range wireless signals such as Bluetooth™ or other short range wireless signals. This configuration is shown in FIG. 5.

FIG. 5 shows an embodiment of a single display (e.g. display 102) showing the device's display screen panel (e.g. a Liquid Crystal Display [LCD], electronic paper) (500), the display's main chassis (502) (often made from plastic or metal), an optional battery (504), an optional orientation sensor (506) and an optional camera (508). The display's optional clasps (400) and optional electrical connections are also shown (404). As previously discussed, in some embodiments, the display may additionally receive display information from the device processor using wireless methods, such as Bluetooth™ or other short range wireless protocol (wireless transceiver not shown).

The orientation sensors (506) may transmit the display screen orientation to the computerized device (100), and the computerized device processor may, in turn, be configured (usually by software) to rotate the image displayed on the display screens, usually according to the orientation of at least some of the display screens.

Other variations on these basic schemes are also possible. In some embodiments, the different display screens need not be identical or have identical components. Rather, at least some of the display screens may operate using non-identical types of display screen panels. Here, for example, it may be useful to use a higher power or higher resolution display panel (e.g. screen 106) most of the time, and make the other display panels (e.g. display screens (102), (104) (108) out of a lower performance, lower power utilizing material such as electronic paper displays or electronic ink displays. Here, for this type of tradeoff to be useful, often the less capable displays will often have a power consumption of ½ or less than that of the more capable display.

1. A method of providing multiple display screens to a computerized device, said method comprising:
providing a plurality of display screens, each said plurality of display screens comprising a thin rectangular shape with a display screen on one side, a non-display surface configured to snap into a receptacle, and four thin edge sides;
each said plurality of display screens comprising at least one thin edge side comprising electrical connections disposed to communicate display screen electrical signals either to said display screen, or to a neighboring display screen;
each said plurality of display screens further configured to transition between at least a first configuration where all screens are snapped or folded together in a stacked configuration, one top screen exposed for viewing, one bottom screen disposed to snap into a body of the computerized device, and a second configuration where all screens are disposed in an extended configuration, each screen connected to different screen by the screen edges, so as to provide a continuous display surface;
providing a computerized device with a body equipped with a receptacle configured to hold said plurality of display screens in at least said stacked configuration;
said computerized device additionally equipped with at least one processor, memory, and at least one edge receptacle configured with electrical contacts to transmit display screen electrical signals to at least one edge side of at least one of said plurality of display screens;
wherein in said stacked configuration, said computerized device transmits display screen display information to at least one display screen of said plurality of display;
wherein in said extended configuration, said computerized device transmits display screen display information to at least a first display screen of said plurality of display screens in said extended configuration, and said at least a first display screen in turn relays said display screen display information to at least a second display screen, so that either directly or by relay through other display screens, all display screens in said extended configuration receive display information from said computerized device.

2. The method of claim 1, wherein said display screens snap together via magnetic clasps.

3. The method of claim 1, wherein said display screens snap together via mechanical clasps.

4. The method of claim 1, wherein said plurality of display screens comprises at least four display screens, and said at least four display screens in turn snap together to either form various extended rectangular configurations of display screens.

5. The method of claim 1, wherein said electrical connections additionally communicate power to operate each of said plurality of display screens.

6. The method of claim 1, wherein each screen has its own electrical power storage device.

7. The method of claim 1, wherein said plurality of display screens operate using non-identical types of display screen panels, and wherein at least one of said non-identical display screen panels operates at a higher level of power consumption, at least one of said non-identical display screen panels operates at a lower level of power consumption, and said higher level of power consumption is at least 2× the power of said lower level of power consumption.

8. The method of claim 7, wherein at least one of said non-identical display screen panels is an electronic paper display screen device.

9. The method of claim 1, wherein said computerized device is a smartphone, portable handheld device, tablet computer laptop computer or desktop computer.

10. The method of claim 1, wherein said processor transmits a full screen of display information to said plurality of display screens is in said extended configuration, and wherein said processor automatically either automatically transmits only a fraction of said full screen of display information to the top screen when said display screens are in said stacked configuration, or alternatively rescales the size and resolution of said full screen of display information so as to display a scaled-down version of said full screen of display information to said top screen.

11. The method of claim 10, wherein when in said extended configuration, said plurality of display screens function as one larger display screen.

12. The method of claim 1, wherein at least some of said display screens are touch sensitive display screens.

13. The method of claim 1, wherein said plurality of display screens snap together to form two separate arrays of display screens, and where each display screen array may be configured to face at a different angle.

14. The method of claim 1, wherein said receptacle operates to receive said plurality of display screens by either mechanical or magnetic clasps.

15. The method of claim 1, wherein at least some of said plurality of display screens additionally have orientation sensors, and wherein said processor or said display screens are configured to rotate the image displayed on said display screens according to the orientation of at least some of said plurality of display screens.

16. The method of claim 1, wherein at least some of said plurality of display screens area additionally equipped with at least one video camera.

17. The method of claim 1, wherein at least some of said plurality of display screens additionally comprise a stand or support for a stand.

18. The method of claim 1, wherein at least some of said plurality of display screens further comprise a wireless transceiver, and wherein said display screen is capable of obtaining display screen information by wireless transmissions from said computerized device.
